(19) United States
(12) Patent Application Publication
(10) Pub. No.: US 2020/0145540 A1
(43) Pub. Date: May 7, 2020

(54) GENERATING SOURCE IDENTIFYING APPARATUS AND IMAGE FORMING APPARATUS

(71) Applicant: TOSHIBA TEC KABUSHIKI KAISHA, Tokyo (JP)

(72) Inventor: Masao YAMAGUCHI, Katsushika Tokyo (JP)

(73) Assignee: TOSHIBA TEC KABUSHIKI KAISHA, Tokyo (JP)

(21) Appl. No.: 16/538,022

(22) Filed: Aug. 12, 2019

(30) Foreign Application Priority Data
Nov. 2, 2018 (JP) 2018-207158

(51) Int. Cl. H04N 1/00; G10L 25/51; H04R 1/02

(52) U.S. Cl. CPC H04N 1/00007; G10L 25/51; H04N 2201/0094; H04N 1/00244; H04N 1/00037; H04R 1/028

(57) ABSTRACT

According to one embodiment, a generation source identifying apparatus and an image forming apparatus capable of identifying a generation source of abnormal sound are provided. The generation source identifying apparatus includes a memory and a processor. The memory is configured to store information on a driving frequency of a plurality of driving mechanisms. The processor is configured to detect an abnormal sound from sound of the plurality of driving mechanisms, determine a generation interval of the abnormal sound, and identify a respective driving mechanism of the plurality of driving mechanisms as a generation source of the abnormal sound based on the generation interval of the abnormal sound and the information stored in the memory.

### CROSS-REFERENCE TO RELATED APPLICATION

This application is based upon and claims the benefit of priority from Japanese Patent Application No. 2018-207158, filed Nov. 2, 2018, the entire contents of which are incorporated herein by reference.

### FIELD

Embodiments described herein relate generally to a generation source identifying apparatus and an image forming apparatus.

### BACKGROUND

An apparatus such as an image forming apparatus including a plurality of driving mechanisms, such as a motor, a roller, a fan, a gear, and the like, is known. In such an apparatus, abnormal sound, such as impact sound or the like, may be generated due to wear of the driving mechanism or the like. However, when a plurality of driving mechanisms is present, it is difficult to identify a generation source of the abnormal sound. In particular, because the image forming apparatus includes a plurality of driving mechanisms in a case, it is difficult to identify the generation source of the abnormal sound.

### DESCRIPTION OF THE DRAWINGS

FIG. 1 is a diagram showing an example of an outline of an image forming apparatus according to a first embodiment;

FIG. 2 is a block diagram showing an example of a configuration of the image forming apparatus;

FIG. 3 is a diagram showing an example of a table stored in the image forming apparatus;

FIG. 4 is a diagram showing an example of a flowchart of processes according to the first embodiment performed by a processor of FIG. 2 or processes according to a second embodiment performed by a processor of FIG. 8;

FIG. 5 is a diagram in which a frequency of operation sound including abnormal sound is analyzed;

FIG. 6 is a diagram showing sound pressure level - time specification for sound of a 10 kHz frequency;

FIG. 7 is a diagram showing an example of a roller for paper conveyance and a gear for the corresponding roller; and

FIG. 8 is a block diagram showing a configuration of a portable device according to the second embodiment.

### DETAILED DESCRIPTION

Embodiments provide a generation source identifying apparatus and an image forming apparatus capable of identifying a generation source of abnormal sound.

In general, according to one embodiment, a generation source identifying apparatus includes a memory and a processor. The memory is configured to store information on a driving frequency of a driving mechanism. The processor is configured to detect abnormal sound from sound of a plurality of driving mechanisms, specify a generation interval of the detected abnormal sound, and identify a driving mechanism that is a generation source of the abnormal sound based on the specified generation interval of the abnormal sound and the information stored in the memory.

Hereinafter, some embodiments will be described with reference to drawings. Also, each drawing used to describe the following embodiment may omit a configuration for description.

### First Embodiment

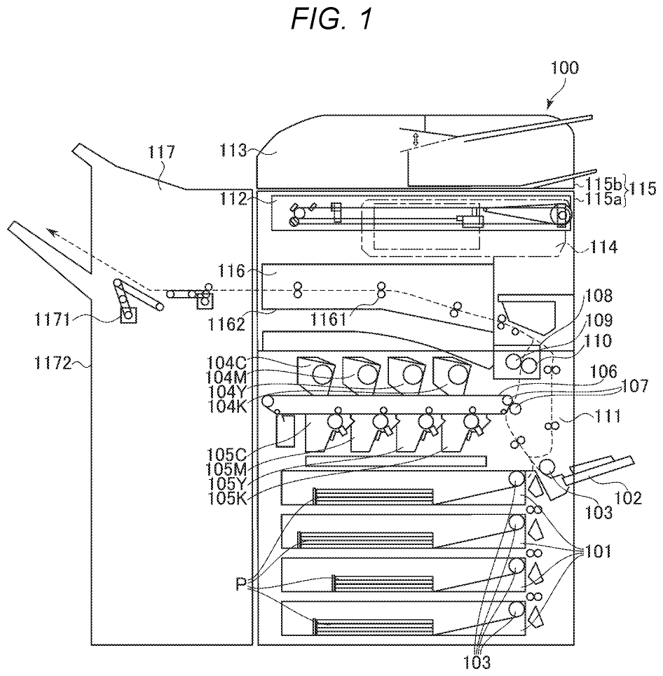

FIG. 1 is a diagram showing an example of an outline of an image forming apparatus 100 according to a first embodiment. The image forming apparatus 100 will be described with reference to FIG. 1. The image forming apparatus 100 is, for example, a multifunction peripheral (MFP), a photocopier, a printer, a facsimile machine, or the like. The image forming apparatus 100 has, for example, a print function, a scan function, a copy function, a facsimile function, and the like. The image forming apparatus 100 includes, for example, a paper feed tray 101, an manual feed tray 102, a paper feed roller 103, a toner cartridge 104, an image forming unit 105, a transfer belt 106, a transfer roller 107, a fixing unit 108, a heating unit 109, a pressurizing roller 110, a duplex unit 111, a scanner 112, an original transmitting device 113, an operation panel 114, and a case 115. Also, the image forming apparatus 100 includes a plurality of rotation mechanisms that are rotated and driven, such as a gear, a motor, a roller, a fan, and the like. A relay unit 116 and a finisher 117 are connected to the image forming apparatus 100. The image forming apparatus 100 is an example of a generation source identifying apparatus.

The paper feed tray 101 accommodates an image forming medium P used for printing. The manual feed tray 102 is a table into which the image forming medium P is manually fed. The paper feed roller 103 is rotated via functions of a motor, a gear transmitting power of the motor, and the like. Accordingly, the paper feed roller 103 discharges the image forming medium P from the paper feed tray 101 or the manual feed tray 102.

The toner cartridge 104 stores a recording material, such as toner or the like, to be supplied to the image forming unit 105. The toner cartridge 104 supplies toner to the image forming unit 105 by functions of a motor and the like. The image forming apparatus 100 includes one or more toner cartridges 104. For example, the image forming apparatus 100 includes, as shown in FIG. 1, the four toner cartridges 104 of a toner cartridge 104C, a toner cartridge 104M, a toner cartridge 104Y, and a toner cartridge 104K. The toner cartridge 104C, the toner cartridge 104M, the toner cartridge 104Y, and the toner cartridge 104K respectively store recording materials corresponding to colors of cyan, magenta, yellow, and key (black) (CMYK). A color of the recording material stored in the toner cartridge 104 may be not only each color of CMYK, but also any other color.

Each image forming unit 105 includes a photoconductive drum, a developing device, and the like. The developing device develops an electrostatic latent image on the photoconductive drum by using the recording material supplied from the toner cartridge 104. Accordingly, a toner image is formed on the photoconductive drum. An image formed on the photoconductive drum is transferred (primary transfer) onto the transfer belt 106. The image forming apparatus 100 includes one or more image forming units 105. For example, the image forming apparatus 100 includes, as shown in FIG. 1, the four image forming units 105 of an image forming unit 105C, an image forming unit 105M, an image forming unit 105Y, and an image forming unit 105K. The image forming unit 105C, the image forming unit 105M, the image forming unit 105Y, and the image forming unit 105K respectively form images with recording materials corresponding to colors of CMYK.

The transfer belt 106 is, for example, an endless belt, and is rotatable by functions of a motor, gear transmitting power of the motor, a roller, and the like. The transfer belt 106 conveys an image transferred from each image forming unit 105 to a position of the transfer roller 107 by rotating.

The transfer roller 107 includes two rollers that face each other. The transfer roller 107 transfers an image formed on the transfer belt 106 onto the image forming medium P (secondary transfer) passing between the transfer rollers 107.

The fixing unit 108 applies heat and pressure to the image forming medium P onto which an image is transferred. Accordingly, the image transferred onto the image forming medium P is fixed. The fixing unit 108 includes the heating unit 109 and the pressurizing roller 110, which face each other.

The heating unit 109 is, for example, a roller including a heat source for heating the heating unit 109. The heat source is, for example, a heater. The roller heated by the heat source heats the image forming medium P.

Alternatively, the heating unit 109 may include an endless belt suspended by a plurality of rollers. For example, the heating unit 109 includes a plate-shaped heat source, an endless belt, a belt conveyance roller, a tension roller, and a press roller. The endless belt is, for example, a film-shaped member. The belt conveyance roller drives the endless belt. The tension roller applies tension to the endless belt. The press roller includes an elastic layer formed on a surface. The plate-shaped heat source has a heating unit side contacting an inner side of the endless belt to be pressed in a direction of the press roller, thereby forming a fixing nip having a predetermined width between the press rollers. Because the plate-shaped heat source is configured to heat while forming a nip region, responsiveness during current flow is higher than that of a heating method by a halogen lamp.

The pressurizing roller 110 pressurizes the image forming medium P passing between the pressurizing roller 110 and the heating unit 109.

The duplex unit 111 enables printing on a back surface of the image forming medium P. For example, the duplex unit 111 turns the image forming medium P over by switching back the image forming medium P by using a roller or the like.

The scanner 112 is, for example, an optical reduction type including an imaging device such as a charge-coupled device (CCD) image sensor. Alternatively, the scanner 112 is a contact image sensor (CIS) type including an imaging device such as a complementary metal-oxide-semiconductor (CMOS) image sensor or the like. Alternatively, the scanner 112 may be any other well-known type.

The original transmitting device 113 is also called as, for example, an auto document feeder (ADF). The original transmitting device 113 conveys originals placed on an original tray one by one. An image of the conveyed original is read by a scanner. Here, the original transmitting device 113 may include a scanner for reading an image from a back surface of the original. The original transmitting device 113 includes a roller and the like for conveying the original. The roller is rotated by functions of a motor, a gear transmitting power of the motor, and the like.

The operation panel 114 includes a man-machine interface or the like, which performs input and output between the image forming apparatus 100 and an operator of the image forming apparatus 100. The operation panel 114 includes, for example, a button, a touch panel, and the like to be operated by the operator. In the touch panel, for example, a display, such as a liquid crystal display or an organic electroluminescent (EL) display, and a pointing device by a touch input are stacked. Thus, the button and the touch panel function as an input device for receiving an operation by the operator. In addition, the display included in the touch panel functions as a display device for notifying the operator of various types of information.

The case 115 accommodates each component of the image forming apparatus 100. The case 115 is divided into two portions of a case 115a and a case 115b. The case 115a accommodates each component other than the original transmitting device 113 of the image forming apparatus 100. Accordingly, the case 115a accommodates the plurality of rotation mechanisms included in the image forming apparatus 100 except for the original transmitting device 113. The case 115b accommodates each component included in the original transmitting device 113. Accordingly, the case 115b accommodates the plurality of rotation mechanisms included in the original transmitting device 113.

The relay unit 116 conveys the image forming medium P discharged from the image forming apparatus 100 to the finisher 117. The relay unit 116 includes a conveyance roller 1161 and a case 1162.

The conveyance roller 1161 is rotated by functions of a motor, a gear transmitting power of the motor, and the like. Accordingly, the conveyance roller 1161 conveys the image forming medium P. The case 1162 accommodates each component of the relay unit 116. The case 1162 accommodates the rotation mechanism included in the relay unit 116.

The finisher 117 may be mounted on the image forming apparatus 100 without the relay unit 116. In this case, the relay unit 116 may not be attached to the image forming apparatus 100.

The finisher 117 is a device having a function of performing a certain post-process on the image forming medium P discharged from the image forming apparatus 100. For example, the finisher 117 includes a function of performing stapling, punching, folding, cutting, binding, or another post-process on the image forming medium P discharged from the image forming apparatus 100. Alternatively, the finisher 117 has a function of classifying and accumulating the image forming medium P discharged from the image forming apparatus 100. The finisher 117 includes a driving unit 1171 and a case 1172.

The driving unit 1171 is driven to execute a post-process on the image forming medium P, for example. Alternatively, the driving unit 1171 is driven to convey the image forming medium P. The driving unit 1171 includes, for example, a plurality of rotation mechanisms such as a motor, a roller, a gear, and the like. The case 1172 accommodates each component of the finisher 117. The case 1172 accommodates the plurality of rotation mechanisms included in the finisher 117.

The image forming apparatus 100, the relay unit 116, and the finisher 117 typically include a rotation mechanism in addition to those described above.

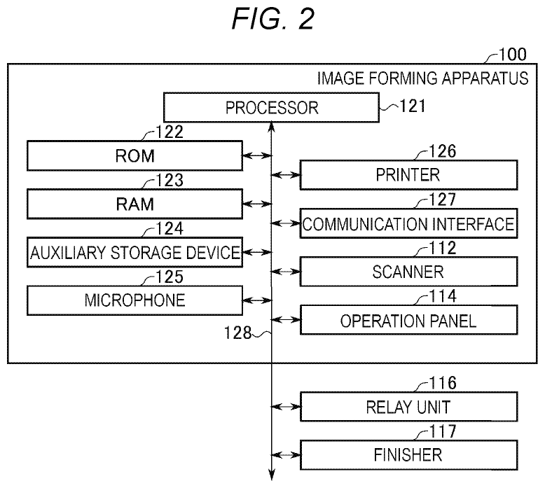

The image forming apparatus 100 will be further described with reference to FIG. 2. FIG. 2 is a block diagram showing an example of a configuration of the image forming apparatus 100 according to the first embodiment. For example, the image forming apparatus 100 includes a processor 121, a read-only memory (ROM) 122, a random-access memory (RAM) 123, an auxiliary storage device 124, a microphone 125, a printer 126, a communication interface 127, the scanner 112, and the operation panel 114. Such components are connected via a bus 128 or the like.

The processor 121 corresponds to a central portion of a computer that performs processes, such as calculations, controls, and the like, required for operations of the image forming apparatus 100. The processor 121 controls each component such that various functions of the image forming apparatus 100 are realized, based on a program such as system software, application software, firmware, or the like, stored in the ROM 122, the auxiliary storage device 124, or the like. Here, a part or all of the program may be incorporated in a circuit of the processor 121. The processor 121 is, for example, a central processing unit (CPU), a micro processing unit (MPU), a system on chip (SoC), a digital signal processor (DSP), a graphics processing unit (GPU), an application specific integrated circuit (ASIC), a programmable logic device (PLD), a field-programmable gate array (FPGS), or the like. Alternatively, the processor 121 is a combination thereof.

The ROM 122 corresponds to a main storage device of the computer centered on the processor 121. The ROM 122 is a non-volatile memory used exclusively for reading data. The ROM 122 stores the program. The ROM 122 stores data or various setting values which are used to perform various processes by the processor 121.

The RAM 123 corresponds to a main storage device of the computer centered on the processor 121. The RAM 123 is a memory used for reading and writing data. The RAM 123 is used as a so-called work area or the like for temporarily storing data used by the processor 121 to perform various processes.

The auxiliary storage device 124 corresponds to an auxiliary storage device of the computer centered on the processor 121. The auxiliary storage device 124 is, for example, an electric erasable programmable read-only memory (EEPROM), a hard disk drive (HDD), a solid state drive (SSD), an embedded multimedia card (eMMC), or the like. The auxiliary storage device 124 may store the above program. The auxiliary storage device 124 stores data used by the processor 121 to perform various processes, data or various setting values generated by the processes of the processor 121, and the like. Also, the image forming apparatus 100 may include an interface into which a storage medium, such as a memory card, a universal serial bus (USB), or the like, is insertable as the auxiliary storage device 124. The interface reads information stored in the storage medium.

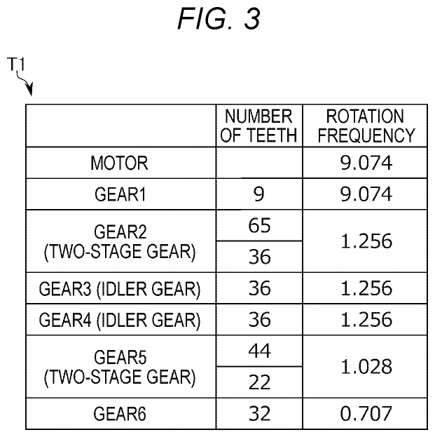

The ROM 122 or the auxiliary storage device 124 stores a table T1 shown in FIG. 3. FIG. 3 is a diagram showing an example of a table stored in the image forming apparatus 100. The table T1 includes information on a rotation mechanism, such as a motor, a gear, a roller, or the like, mounted on the image forming apparatus 100, the relay unit 116, and the finisher 117. For example, the table T1 stores the number of teeth of each gear and a rotation frequency of each rotation mechanism. Also, the image forming apparatus 100 obtains information on the rotation mechanisms mounted on the relay unit 116 and the finisher 117 from the relay unit 116 or the finisher 117, for example, under the control of the processor 121. Alternatively, the information on the rotation mechanisms mounted on the relay unit 116 and the finisher 117 may be pre-stored in the ROM 122 or the auxiliary storage device 124. The image forming apparatus 100 may obtain the information on the rotation mechanisms mounted on the relay unit 116 and the finisher 117 from a network, such as a local area network (LAN), the Internet, or the like, under the control of the processor 121. As described above, the ROM 122 or the auxiliary storage device 124 is an example of a memory storing information on the rotation frequency of the rotation mechanism. The auxiliary storage device 124 may store information similar to the table T1 in a form other than a table.

The auxiliary storage device 124 also stores data of sound input to the microphone 125 of the image forming apparatus 100, when abnormal sound is not generated. The storing of the data is based on, for example, the control by the processor 121. The data will be hereinafter referred to as “history data”.

The program stored in the ROM 122 or the auxiliary storage device 124 includes a program for executing a process described below. For example, the image forming apparatus 100 is transferred to an administrator or the like of the image forming apparatus 100 while the program is stored in the ROM 122 or the auxiliary storage device 124. However, the image forming apparatus 100 may be transferred to the administrator or the like while the program is not stored in the ROM 122 or the auxiliary storage device 124. In addition, the image forming apparatus 100 may be transferred to the administrator or the like while a program different from the program is stored in the ROM 122 or the auxiliary storage device 124. Then, the program for executing the process described below may be separately transferred to the administrator or the like, and written to the ROM 122 or the auxiliary storage device 124 under an operation of the administrator, a service person, or the like. The transferring of the program may be realized by, for example, recording the program on a removable storage medium, such as a magnetic disk, a magneto-optical disk, an optical disk, a semiconductor memory, or the like, or downloading the program via a network or the like.

The microphone 125 is provided inside or outside the case 115 of the image forming apparatus 100. The microphone 125 converts and outputs input sound into a signal (sound data). The output signal (sound data) is input to the processor 121 or the like. A plurality of the microphones 125 may be provided. Also, the microphone 125 may be provided inside or outside the case 1162 or case 1172 of the relay unit 116 or finisher 117.

The printer 126 performs an operation related to printing. The printer 126 includes, for example, the paper feed roller 103, the toner cartridge 104, the image forming unit 105, the transfer belt 106, the transfer roller 107, the fixing unit 108, the duplex unit 111, and the like. Also, the printer 126 may also include a circuit for controlling each of the components, and the like.

The communication interface 127 is an interface for the image forming apparatus 100 to communicate via a network or the like. The bus 128 includes a control bus, an address bus, a data bus, and the like to transmit signals transmitted and received by each component of the image forming apparatus 100.

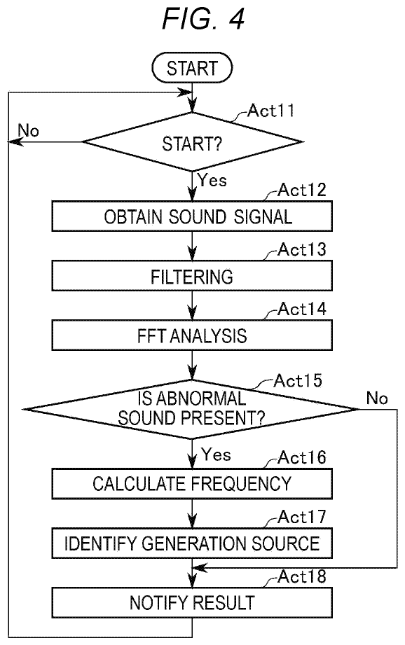

Hereinafter, an operation of the image forming apparatus 100 according to an embodiment will be described based on FIG. 4 and the like. The content of processes in the following description of the operation is an example, and various processes capable of obtaining the same result may be appropriately used. FIG. 4 is a flowchart of processes performed by the processor 121 of the image forming apparatus 100. The processor 121 performs the processes based on, for example, a program stored in the ROM 122, the auxiliary storage device 124, or the like. When the processor 121 performs Act (N+1) after performing Act N (N is a natural number), the description thereof may be omitted.

The processor 121 starts the processes shown in the flowchart of FIG. 4, for example, with the start of operation of the image forming apparatus 100. Alternatively, for example, the processor 121 starts the processes shown in FIG. 4, based on the transition of the image forming apparatus 100 to a maintenance mode.

In Act 11, the processor 121 stands by for an operation instructing to start detection of abnormal sound and detection of a generation source of the abnormal sound. When the operation is performed, the processor 121 determines Yes in Act 11 and performs Act 12. The operation is, for example, performed by the operator of the image forming apparatus 100, such as a service person, or the like.

In Act 12, the processor 121 starts to obtain signal (sound data) output from the microphone 125. In Act 13, the processor 121 performs filtering on the signal (sound data) obtained in Act 12. In Act 14, the processor 121 performs fast Fourier transform (FFT) analysis on the signal (sound data) on which the filtering is performed in Act 13. The processor 121 may perform another process instead of or in addition to Act 13 and Act 14.

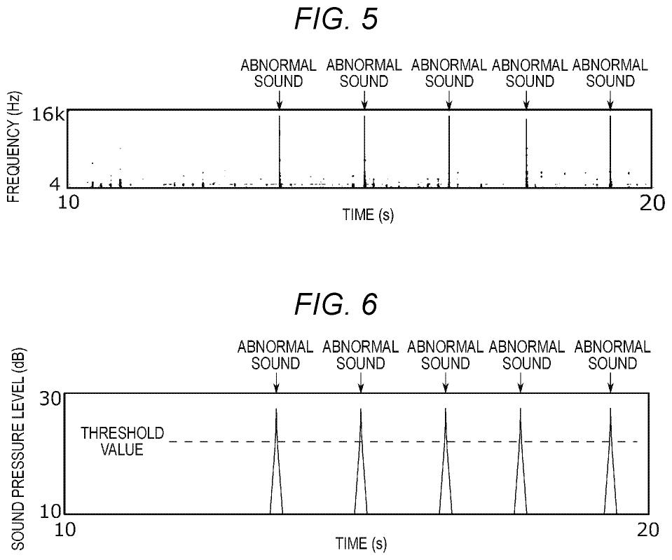

In Act 15, the processor 121 determines whether abnormal sound is generated by using the signal (sound data) on which the FFT analysis is performed in Act 14. The processor 121 detects the abnormal sound by using, for example, a method of (a1) or (a2) below. (a1) The processor 121 performs sampling of sound data and frequency analysis. Then, the processor 121 compares a result of the frequency analysis with history data read from the auxiliary storage device 124, by using a comparator or the like. Here, the processor 121 performs comparison by using a high frequency component of which a frequency is equal to or higher than a threshold value TH1. This is because a low frequency component is masked by stationary sound, such as motor sound, fan sound, or the like, and thus even when abnormal sound is generated, the abnormal sound is not noticeable and does not cause a problem such as noise. Thus, for example, 6 kHz where stationary sound is not noticeable is set as the threshold value TH1 to determine sound of 6 kHz or higher as problem sound, and it is determined that abnormal sound is present when a difference of sound pressure levels between the result of the frequency analysis and the history data is higher than a specified value. For example, in sound shown in a graph of FIG. 5, it is determined that abnormal sound is generated five times. FIG. 5 is a diagram in which a frequency of operation sound including abnormal sound is analyzed. In the graph of FIG. 5, a vertical axis indicates a frequency and a horizontal axis indicates time. A black portion inside the graph indicates that a sound pressure level of sound indicated by the block portion is high. (a2) The processor 121 determines sound of which a sound pressure level is equal to or higher than a threshold value TH2 as abnormal sound. For example, FIG. 6 is a diagram showing a sound pressure level—time axis for sound of a 10 kHz frequency. In this example, it is determined that abnormal sound is generated five times. When the frequency is 6 kHz or higher, a graph of characteristics similar to FIG. 6 may be obtained.

The threshold value TH1 and the threshold value TH2 are determined by, for example, a designer, an administrator, a service person, an operator, or the like of the image forming apparatus 100. When the abnormal sound is detected, the processor 121 determines Yes in Act 15 and performs Act 16.

In Act 16, the processor 121 obtains a frequency Hz of the abnormal sound. The frequency of the abnormal sound indicates the number of times the abnormal sound is generated per second. The processor 121 obtains the frequency of the abnormal sound by, for example, dividing one second by a generation internal of the abnormal sound. The processor 121 obtains the frequency of the abnormal sound by using, for example, a method of (b1) or (b2) below. (b1) The processor 121 determines a frequency of abnormal sound by considering a moment when a sound pressure level of the abnormal sound is equal to or higher than a pre-determined threshold value as a generation timing of the abnormal sound. (b2) The processor 121 obtains a generation interval of abnormal sound by performing an image process on an image or the like in which sound is graphed.

For example, when it is assumed that a first abnormal sound generation time is at 13.633 seconds and a fifth abnormal sound generation time is at 19.293 seconds, a cycle of a generation interval is 1.415 seconds (e.g., (19.293-13.633)/4) and a generation frequency is 0.707 Hz (e.g., 1/1.415).

In Act 17, the processor 121 identifies a generation source of the abnormal sound. For example, the processor 121 identifies, as the generation source of the abnormal sound, a rotation mechanism of a rotation frequency equal to the frequency obtained in Act 16, by referring to the table T1.

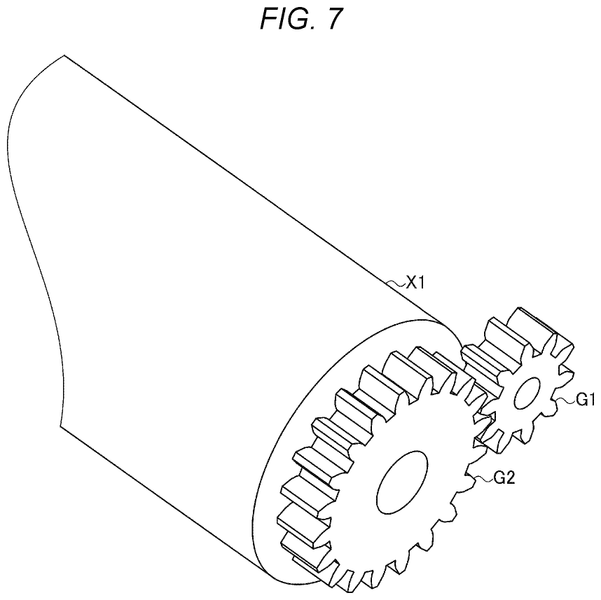

The processor 121 may obtain the rotation frequency via calculation. For example, a case of a gear G1 and a gear G2 for a roller X1 shown in FIG. 7 is considered. FIG. 7 is a diagram showing an example of the roller X1 for paper conveyance and a gear for the roller X1. For example, when a gear attached to a motor M1 of a rotation speed Rm rpm is the gear G1, a rotation speed R1 Hz of the motor M1 and the gear G1 is obtained by Rm/60 Hz. Also, when the number of teeth of the gear G1 is Z1 and the number of teeth of the gear G2 connected to the gear G1 is Z2, a rotation frequency of the gear G2 is determined by R1×(Z1/Z2) rpm. In FIG. 7, the number of teeth of the gear G1 is 10. The number of teeth of the gear G2 is 20. Accordingly, the rotation frequency of the gear G2 is R1×(10/20)=0.5×R1 rpm. Also, the roller X1 rotates integrally with the gear G2. Accordingly, a rotation frequency of the roller X1 is 0.5×R1 rpm, which is the same as that of the gear G2. A rotation frequency may be obtained via the same calculation even when three or more gears are connected. Also, a rotation frequency may be obtained in the same manner even for a rotation mechanism other than a roller rotating integrally with a gear. As described above, the table T1 is not limited as long as a rotation frequency or information from which the rotation frequency can be calculated is included with respect to each rotation mechanism.

The processor 121 may allow an error within a certain range when determining whether the frequency obtained in Act 16 and a rotation frequency of a rotation mechanism have the same value. During a process of Act 17, the processor 121 reads some or all of the table T1 into the RAM 123. Accordingly, the RAM 123 is an example of a memory storing information on a rotation frequency.

According to the table T1, a rotation frequency of a gear 6 is 0.707 Hz. Accordingly, when a generated frequency obtained in Act 16 is 0.707 Hz, it is determined that a generation source of abnormal sound is the gear 6.

After the process of Act 17, the processor 121 performs Act 18. When it is determined that the abnormal sound is not generated, the processor 121 determines No in Act 15 and performs Act 18. In Act 18, the processor 121 controls each component to notify results of detecting the abnormal sound and detecting the generation source of the abnormal sound. Content of such notification includes, for example, whether the processor 121 was able to detect the abnormal sound, when the abnormal sound is detected, whether the processor 121 was able to detect the generation source, and when the generation source of the abnormal sound is detected, what was the generation source. For example, the processor 121 controls the touch panel of the operation panel 114 to display an image including the contention of notification. After a process of Act 18, the processor 121 returns to Act 11.

The image forming apparatus 100 according to the first embodiment identifies the generation source of the abnormal sound even when a plurality of driving mechanisms are present. Thus, time taken for the service person of the image forming apparatus 100 to respond to the abnormal sound may be reduced.

### Second Embodiment

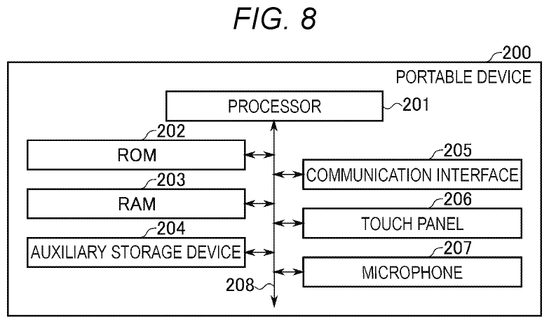

In a second embodiment, an example of a generation source identifying apparatus that detects abnormal sound generated from a rotation mechanism included in an image forming apparatus or the like and identifies a generation source of the abnormal sound will be described. A portable device 200 that is an example of the generation source identifying apparatus will be described based on FIG. 8. FIG. 8 is a block diagram showing an example of a configuration of the portable device 200 according to the second embodiment. The portable device 200 is, for example, a general-purpose device such as a laptop personal computer (PC), a tablet PC, a smartphone, or the like. Alternatively, the portable device 200 is an exclusive device having a function for identifying a generation source of abnormal sound. For example, the portable device 200 includes a processor 201, a ROM 202, a RAM 203, an auxiliary storage device 204, a communication interface 205, a touch panel 206, and a microphone 207. Also, the components are connected by a bus 208 or the like.

The processor 201 corresponds to a central portion of a computer that performs processes, such as calculations, controls, and the like, required for operations of the portable device 200. The processor 201 controls each component such that various functions of the portable device 200 are realized, based on a program such as system software, application software, firmware, or the like, stored in the ROM 202, the auxiliary storage device 204, or the like. Here, a part or all of the program may be incorporated in a circuit of the processor 201. The processor 201 is, for example, a CPU, an MPU, a SoC, a DSP, a GPU, an ASIC, a PLD, a FPGS, or the like. Alternatively, the processor 201 is a combination thereof.

The ROM 202 corresponds to a main storage device of the computer centered on the processor 201. The ROM 202 is a non-volatile memory used exclusively for reading data. The ROM 202 stores the program. The ROM 202 stores data or various setting values which are used by the processor 201 to perform various processes.

The RAM 203 corresponds to a main storage device of the computer centered on the processor 201. The RAM 203 is a memory used for reading and writing data. The RAM 203 is used as a so-called work area or the like for temporarily storing data used by the processor 121 to perform various processes.

The auxiliary storage device 204 corresponds to an auxiliary storage device of the computer centered on the processor 201. The auxiliary storage device 204 is, for example, an EEPROM, a HDD, a SSD, an eMMC, or the like. The auxiliary storage device 204 may store the above program. Also, the auxiliary storage device 204 stores data used by the processor 201 to perform various processes, data or various setting values generated by the processes of the processor 201, and the like.

The auxiliary storage device 204 stores information T2 about a rotation frequency of a rotation mechanism included in an apparatus (hereinafter, referred to as a “target apparatus”) on which detecting of abnormal sound and detecting of a generation source of the abnormal sound are to be performed. For example, the target apparatus is an image forming apparatus having a configuration as described in the first embodiment. The target apparatus such as the image forming apparatus includes a rotation mechanism inside a case. However, the target apparatus may include a part or all of the rotation mechanism outside the case. Alternatively, the target apparatus may not include a case. The portable device 200 obtains the information T2 by, for example, downloading via a network or the like. Alternatively, the portable device 200 obtains the information T2 from, for example, a removable storage medium. Alternatively, the information T2 may be input by an operator of the portable device 200 by operating the portable device 200.

The program stored in the ROM 202 or the auxiliary storage device 204 includes a program for executing a process described below. For example, the portable device 200 is transferred to a user, an administrator, or the like of the portable device 200 while the program is not stored in the ROM 202 or the auxiliary storage device 204. Then, the program separately transferred to the user, the administrator, or the like, is written to the auxiliary storage device 204 under an operation of the administrator or the like. However, the portable device 200 may be transferred to the user, the administrator, or the like while the program is stored in the ROM 202 or the auxiliary storage device 204. The transferring of the program may be realized by, for example, recording the program on a removable storage medium, such as a magnetic disk, a magneto-optical disk, an optical disk, a semiconductor memory, or the like, or downloading the program via a network or the like.

The communication interface 205 is an interface for the portable device 200 to communicate via a network or the like. In the touch panel 206, for example, a display, such as a liquid crystal display or an organic EL display, and a pointing device by a touch input are stacked. The display included in the touch panel 206 functions as a display device for displaying a screen for notifying an operator of the portable device 200 of various types of information. Also, the touch panel 206 functions as an input device for receiving a touch operation by the operator.

The microphone 207 converts and outputs input sound into a signal (sound data). The output signal (sound data) is input to the processor 201 or the like. The portable device 200 may include, instead of the microphone 207, an interface into which sound data is input from a microphone as an external device of the portable device 200. For example, the portable device 200 may include an interface into which sound data inside a case, which is obtained by a microphone mounted on the target apparatus, such as an image forming apparatus or the like, is input. When the portable device 200 is a smartphone or the like, a microphone originally mounted on the smartphone may be used as the microphone 207. In this case, the portable device 200 can suppress costs compared to when a microphone as an external device is used. Also, when a microphone as an external device is usable, the portable device 200 may use a microphone of a characteristic according to a device.

The bus 208 includes a control bus, an address bus, a data bus, and the like to transmit signals transmitted and received by each component of the portable device 200.

Hereinafter, operations of the portable device 200 according to the second embodiment will be described based on FIG. 4 and the like. The content of processes in the following description of the operation is an example, and various processes capable of obtaining the same result may be appropriately used. FIG. 4 is a flowchart of processes performed by the processor 201 of the portable device 200. The processor 201 performs the processes based on, for example, a program stored in the ROM 202, the auxiliary storage device 204, or the like. In other words, the portable device 200 performs the same processes as those shown in the flowchart of FIG. 4 described in the first embodiment. However, in Act 12, the processor 201 obtains the signal (sound data) from the microphone 207 instead of the microphone 125. In Act 17, the processor 201 performs the processes by using the information T2 instead of the table T1.

The operator of the portable device 200 arranges the portable device 200 at a location where sound emitted by the target apparatus is input to the microphone 207. In this state, the portable device 200 performs the same processes as those shown in the flowchart of FIG. 4 to determine whether abnormal sound is generated from the target apparatus. Then, when it is determined that the abnormal sound is generated, the portable device 200 identifies which rotation mechanism included in the target apparatus is a generation source of the abnormal sound. Accordingly, the portable device 200 is able to identify the rotation mechanism that is the generation source of the abnormal sound in the target apparatus. In addition, because the portable device 200 is portable, the portable device 200 may be used to detect abnormal sound and detect a generation source of various apparatuses.

The first embodiment and the second embodiment may be modified as follows. In the first embodiment, an example of the image forming apparatus 100 is described. However, the same operation is applicable to another apparatus. For example, the same operation is applicable to various apparatuses, such as various industrial machines, various household devices, robots, transport machines, amusement devices, game devices, and the like.

In the first embodiment and the second embodiment, the image forming apparatus 100 and the portable device 200 identify a generation source of abnormal sound generated by a rotation mechanism. However, the image forming apparatus 100 and the portable device 200 may identify a generation source of abnormal sound generated by a driving mechanism other than the rotation mechanism. Here, the driving mechanism is a driving mechanism that periodically repeats the same driving. Examples of such a driving mechanism include a crank, a cam, a pendulum, a balance, and the like. The number of times such a driving mechanism repeats driving per unit time is represented by a driving frequency or the like.

The finisher 117 may include a processor and a storage device. Also, the processor may perform the same processes as those shown in the flowchart of FIG. 4 of the first embodiment. However, the storage device stores a table T3 instead of the table T1. The table T3 includes information on a rotation mechanism, such as a motor, a gear, a roller, or the like, mounted on the finisher 117. In this case, the finisher 117 is an example of a generation source identifying apparatus.

The original transmitting device 113 may include a processor and a storage device. Also, the processor may perform the same processes as those shown in the flowchart of FIG. 4 of the first embodiment. However, the storage device stores a table T4 instead of the table T1. The table T4 includes information on a rotation mechanism, such as a motor, a gear, a roller, or the like, mounted on the original transmitting device 113. In this case, the original transmitting device 113 is an example of a generation source identifying apparatus.

In the first embodiment, it is described that the relay unit 116 and the finisher 117 are connected to the image forming apparatus 100. However, the image forming apparatus 100, the relay unit 116, and the finisher 117 may be collectively referred to as an image forming apparatus.

The image forming apparatus 100 may transmit sound obtained from the microphone 125 to an information processing apparatus, such as a PC, a server, a smartphone, a tablet PC, or the like, via a network or the like. The information processing apparatus may process and analyze the sound transmitted from the image forming apparatus 100 and identify a generation source of abnormal sound. For example, the information processing apparatus is provided in an office where a service person or the like works. Alternatively, the information processing apparatus is held by the service person or the like. In this case, the service person can identify the generation source of the abnormal sound before visiting a place (site) where the image forming apparatus 100 is present, by verifying results of the processes and analysis by the information processing apparatus. Accordingly, the service person is able to examine how to deal with the abnormal sound before visiting the site. Also, the service person can take a replacement part required at the site to the site. As a result, it is possible to reduce time taken to deal with the abnormal sound.

The processor 121 and the processor 201 may realize some or all of processes realized by a program in the above embodiment by a hardware configuration of a circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A generation source identifying apparatus comprising:
a memory configured to store information on a driving frequency of a plurality of driving mechanisms; and
a processor configured to:
detect an abnormal sound from sound of the plurality of driving mechanisms;
determine a generation interval of the abnormal sound; and
identify a respective driving mechanism of the plurality of driving mechanisms as a generation source of the abnormal sound based on the generation interval of the abnormal sound and the information stored in the memory.

2. The generation source identifying apparatus of claim 1, wherein the processor is configured to detect sound having a frequency that is equal to or greater than a threshold value as the abnormal sound.

3. The generation source identifying apparatus of claim 1, further comprising a microphone into which the sound of the plurality of driving mechanisms is an input.

4. The generation source identifying apparatus of claim 3, wherein the generation source is part of a machine that includes the plurality of driving mechanisms.

5. The generation source identifying apparatus of claim 4, wherein the machine is an image forming apparatus.

6. The generation source identifying apparatus of claim 3, wherein the generation source is a portable device separate from a machine that includes the plurality of driving mechanisms.

7. The generation source identifying apparatus of claim 1, wherein the generation source identifying apparatus is included in a server, wherein the server receives an indication of the sound from a device through a network.

8. The generation source identifying apparatus of claim 7, wherein the device is a machine that includes the plurality of driving mechanisms.

9. The generation source identifying apparatus of claim 7, wherein the device is a portable device selectively positionable proximate a machine that includes the plurality of driving mechanisms.

10. The generation source identifying apparatus of claim 1, wherein the processor is configured to provide a notification of the respective driving mechanism to an operator.

11. The generation source identifying apparatus of claim 10, further comprising a display configured to provide the notification to the operator.

12. An image forming apparatus comprising:
a plurality of driving mechanisms that generate operation sound by being driven;
a printer configured to drive the plurality of driving mechanisms to form an image on a medium;
a microphone into which sound of the printer is an input;
a memory configured to store information on a driving frequency of the plurality of driving mechanisms; and
a processor configured to:
detect an abnormal sound from the input to the microphone;
determine a generation interval of the abnormal sound; and
identify a respective driving mechanism of the plurality of driving mechanisms as a generation source of the abnormal sound based on the generation interval of the abnormal sound and the information stored in the memory.

13. The image forming apparatus of claim 12, wherein the plurality of driving mechanisms comprise a rotation mechanism.

14. An image forming apparatus comprising:
a plurality of driving mechanisms;
a printer configured to drive the plurality of driving mechanisms to form an image on a medium;
a microphone configured to acquire sound data regarding sound from the printer; and
a processor configured to:
receive the sound data from the microphone; and
facilitate identifying a respective driving mechanism of the plurality of driving mechanisms as a generation source of an abnormal sound based on a generation interval of the abnormal sound.

15. The image forming apparatus of claim 14, further comprising a memory configured to store information on a driving frequency of each of the plurality of driving mechanisms.

16. The image forming apparatus of claim 15, wherein the processor is configured to:
detect the abnormal sound from the sound data received from the microphone;
determine the generation interval of the abnormal sound; and
identifying the generation source of the abnormal sound based on the generation interval of the abnormal sound and the information stored in the memory.

17. The image forming apparatus of claim 14, further comprising a communication interface configured to facilitate communication with an information processing apparatus.

18. The image forming apparatus of claim 17, wherein the information processing apparatus is a server.

19. The image forming apparatus of claim 17, wherein the information processing apparatus is a portable device.

20. The image forming apparatus of claim 17, wherein the information processing apparatus is configured to:
receive the sound data from the image forming apparatus;
detect the abnormal sound from the sound data acquired from the microphone;
determine the generation interval of the abnormal sound; and
identifying the generation source of the abnormal sound based on the generation interval of the abnormal sound.
